(19) United States
(12) Patent Application Publication
(10) Pub. No.: US 2024/0037344 A1
(43) Pub. Date: Feb. 1, 2024

(54) GENERATING CONVERSATIONAL AI RESPONSE SUGGESTIONS

(71) Applicant: Verint Americas Inc., Alpharetta, GA (US)

(72) Inventor: Timothy Hewitt, Spokane Valley, WA (US)

(21) Appl. No.: 17/815,042

(22) Filed: Jul. 26, 2022

(51) Int. Cl. G06F 40/40

(52) U.S. Cl. CPC G06F 40/40

(57) ABSTRACT

The present disclosure describes methods and systems for suggesting responses generated from an entity's own published information with links to the source of that generated response should provide a quality starting point that is already accurate and brand compliant or, if not, quickly editable to become so. The published information is ingested by the system, and a question/answer transformation process is applied against the ingested data using training language data that is tagged and categorized by intent to generate suggested responses. The suggested response may be presented in a user interface with a link to the URL which was used to construct the response. The suggested responses may be edited if needed.

### BACKGROUND

Conversational artificial intelligence (AI) refers to technologies, such as chatbots or virtual agents, which users can communicate with to interactively. Chatbots use large volumes of data, machine learning, and natural language processing to imitate human interactions by recognizing speech and text inputs to provide responses. However, developing human-written responses is time consuming and typically needs to be approved in a multi-stage approval process, while auto-generating responses without a human in the loop leaves no accountability and can erode brand trust.

### SUMMARY

The present disclosure describes methods and systems for suggesting responses generated from an entity's own published information with links to the source of that generated response should provide a quality starting point that is already accurate and brand compliant, or, if not, quickly editable to become so.

In accordance with an aspect of the disclosure, a method of generating suggested responses is disclosed. The method may include ingesting, by an ingestion component, content data from a knowledgebase; storing the content data in a first application database as extracted data; applying, using a question/answer transformation component, a question and answer process to the extracted data using training data that is tagged by intent to determine suggested response data and a confidence score; storing the suggested response data in a second application database; selecting suggested response data in accordance with the confidence score; and presenting selected suggested response data in a user interface.

In accordance with yet other aspects of the disclosure, a computer system that includes a memory comprising computer-executable instructions; and a processor configured to execute the computer-executable instructions and cause the computer system to perform a method of generating suggested responses that causes the computer system to: ingest, by an ingestion component, content data from a knowledgebase; store the content data in a first application database as extracted data; apply, using a question/answer transformation component, a question and answer process to the extracted data using training data that is tagged by intent to determine suggested response data and a confidence score; store the suggested response data in a second application database; select suggested response data in accordance with the confidence score; and present selected suggested response data in a user interface. A computer-readable medium that contains the computer-executable instructions noted above is also disclosed.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIGS. 1A-1B illustrate example overview schematics of systems that generate conversational AI response suggestions in accordance with embodiments of the present disclosure.

FIG. 2 illustrates an example user interface in accordance with embodiments of the present disclosure.

FIG. 4 illustrates an example flow chart of operations performed by the system of FIGS. 1A and/or 1B to generate suggested responses.

FIG. 4 illustrates an example flow chart of operations performed by the system of FIGS. 1A and/or 1B to present, edit, and/or accept or recommend responses in accordance with embodiments of the present disclosure.

FIG. 5 illustrates example computing systems that may be utilized according to certain embodiments.

### DETAILED DESCRIPTION

### Overview

Conversational AI, or Intelligent Virtual Assistants (IVA), for customer service is a rapidly growing model used by entities to interact with their customers or end users. One of the areas of concern for entities using a conversational AI is brand control and accountability. The present disclosure describes methods and systems for suggesting responses that are to be used by the conversational AI that is generated from an entity's own published information. The suggested responses may be displayed in a user interface together with links to a source that generated the response in order to provide a quality starting point for the development of conversational AI messaging components (e.g., statements, responses, questions to use a part of a conversation with a customer) by a human or AI/ML system, that is accurate and brand compliant, or, if not, quickly editable by a user to become so.

Conversational AI systems are generally structured by grouping “user intents,” which are defined as an answer to the question, “What is the user trying to accomplish or understand?” These “conversational AI intents” are a grouping of one or more user intents to which the conversational AI will respond. Conversational AI intents may be created on a case-by-case basis in accordance with the value to customer and business needs. For example, a bank may wish to respond differently to replacing a debit card if the card was stolen versus if the card was damaged or if the reason for a replacement is unstated. The grouping of user intents may result in a more general response. For example, a “Replace Damaged Card” conversational AI intent may handle user questions such as “Can I replace my card if it's cracked?” or “I need a new card because mine is cracked. How long will it take to get here?” The direct answer to the first is not an appropriate response to the second and vice versa. As such, a good response tends to be more of a summarization of relevant information with a follow-up to offer a relevant workflow or service.

Implementations of the present disclosure reduce the high costs associated with human response writing. There is a significant amount of creative time involved in crafting conversational AI responses, as well as general requirements imposed by marketing and legal before the response can be provided to the public. In particular, it is desirable to provide responses that are accurate, compliant, and consistent with the brand image. Thus, the implementations described by the present disclosure improve upon conventional response writing by suggesting responses generated by text summarization of documents within an entity's own knowledgebase in conjunction with question-answering methods. This provides a set of suggested responses that are largely accurate, needing only a limited amount of human review.

### Example Environment and Processes

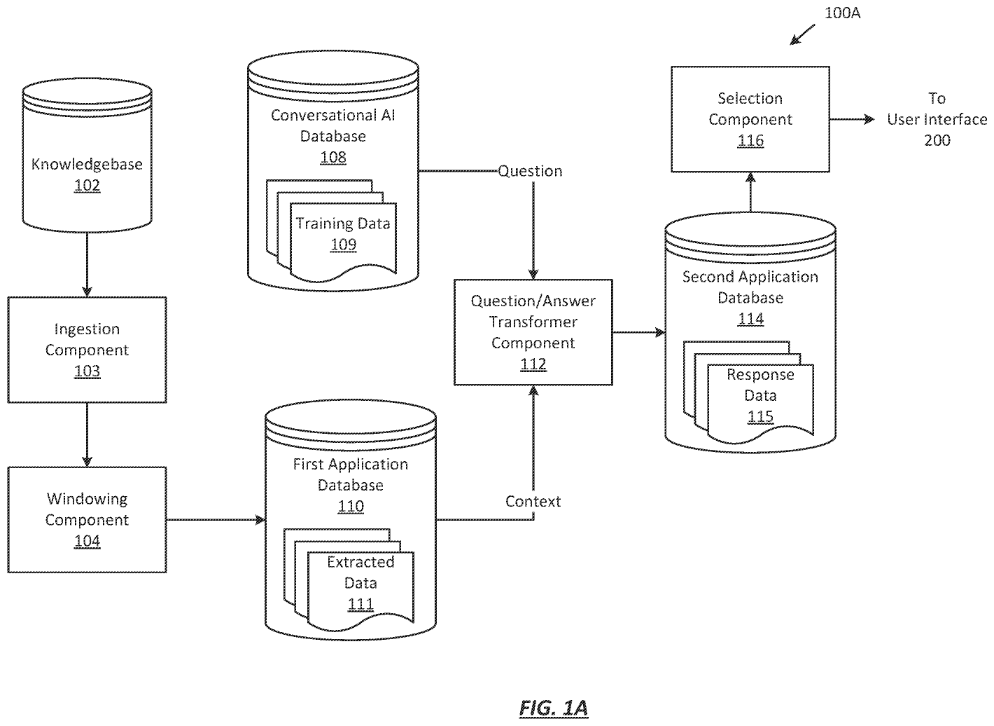

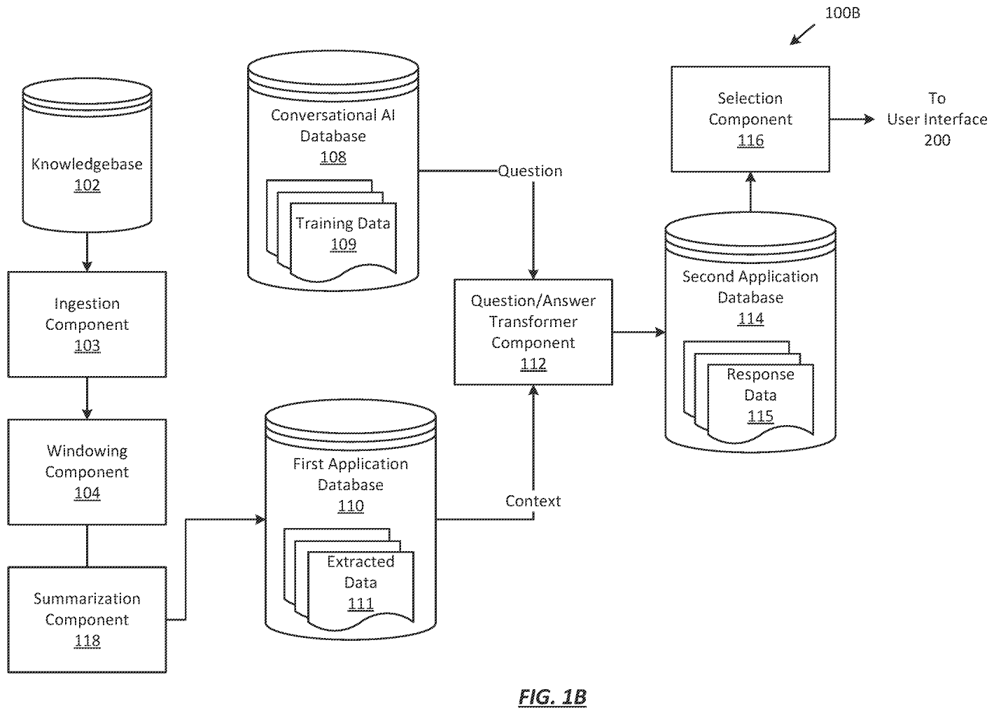

FIGS. 1A-1B illustrate example overview schematics of systems that generate conversational AI response suggestions in accordance with the present disclosure.

With reference to FIG. 1A, there is illustrated a system 100A for generating conversational AI response suggestions. The system 100A includes a knowledgebase 102, an ingestion component 103, a windowing component 104, a first application database 110, a conversational AI database 108, a question/answer transformer component 112, a second application database 114, and a selection component 116.

The knowledgebase 102 is a repository that collects, stores, and shares knowledge, often about a particular company's products and/or services. The knowledgebase 102 may include a variety of different articles, such as frequently asked questions (FAQs), troubleshooting guides, user manuals, or any other information (herein “content data”) that may be relevant to the user looking for information. The content within the articles may include text, graphs, videos, diagrams, or whatever format is best suited to convey the information users are looking for and is categorized in a way that makes the most sense from a user perspective.

The content data may be ingested into the first application database 110 by the ingestion component 103. The application database 110 is used as a staging repository to store the content data before being processed by the question/answer transformer component 112, as described below. The ingestion component 103 may ingest content data from the knowledgebase 102 using web scraping or other extraction techniques, such as a database dump using SQL or reading files directly from an operating system directory tree. Each item of extracted data from the knowledgebase 102 is stored together with information about its source in extracted data 111A.

Optionally or additionally, the windowing component 104 may perform a windowing process on the ingested content data such that the same document within the knowledgebase 102 produces multiple summarizations to use as contexts for the question/answer transformer component 112. Herein, a “context” is a part of the ingested content data that surrounds other words or passages in the content data and provides insight into the meaning of the words or passage. Using the windowing process, each item of content data (for example, text within a knowledgebase document) may produce multiple results for the question/answer component 112, as described below. In accordance with aspects of the present disclosure, if the content data is a knowledgebase document, the windowing component 104 may be configured to ingest a predetermined number of characters in an ingested knowledgebase document in “steps.” Thus, when content data is ingested, the system 100 will initially process the first predetermined number of characters in a knowledgebase document. Thereafter, the “step” is used to set a new starting location in the knowledgebase document, and the next predetermined number of characters is processed from the new starting location. This windowing process continues until all characters in the knowledgebase document are ingested. For example, if the predetermined number of characters is 100 and the step is five, the system 100A would process characters 1-100 in the knowledgebase document, then 5-105, then 10-110, and so on, until the window component 104 ingests the final character. The windowing process may be used on other types of content data, such as frequently asked questions (FAQs), product or service descriptions and documentation, or any other text-based data.

As shown in FIG. 1B, in the example system 100B, a summarization component 118 may summarize the ingested content data. For example, a pretrained transformer model, such as the GOOGLE Text-to-Text Transfer Transformer (T5) may be used to perform automatic summarization. T5 is a natural language processing (NLP) technique that converts all text-based language problems into a text-to-text format. The output is a text string that is derived from pre-trained input text strings and data to be summarized (i.e., the content data). While the present disclosure utilizes T5, it is noted that other models may be trained to perform this task. In some implementations, a human summarization may be performed.

The summarization component 118 may be used to remove superfluous subject matter in each item of extracted content data that is unrelated to a predetermined conversational AI intent such that the content data may be more easily processed by the question/answer transformer component 112 to provide answers to questions that are posed by customers interacting with the conversational AI. For example, content data extracted from an airline's knowledgebase 102 directed to baggage weight limits may be summarized by the summarization component 118 to remove information about baggage size and checked bag fees to leave only information about weight limits. If the summarization component 118 is used to perform summarization of the ingested content data, then the summaries are stored in the extracted data 111B together with the extracted content data and information about the source of each item of the content data.

The conversational AI database 108 contains training data 109 that is tagged and categorized by intent. “Intent,” as used herein, is defined as a grouping of language aligned to a task. For example, if several users are trying to accomplish the same task, their inputs could be said to have the same intent. Example training data 109 is shown below in Table 1.

TABLE 1

| Intent | Training Language |
|---|---|
| Account History | balance history? |
| Account History | Can I see details of an account? |
| Account History | Can I see my balance history on a specific account? |
| Account History | can I see a detailed version of my account? |
| Account History | can I see my account details? |
| Change Password | can't remember my password to access my accounts |
| Change Password | i lost my password |
| Change Password | can a member reset their own password? |
| Change Password | how do i reset my system password? |
| Change Password | don't remember my password |

The training data 109 may be acquired from an intelligent virtual assistant (for example, a chatbot, conversational AI, AI assistant, etc.). Training data 109 may also be gathered from customer care conversations, grouping customer requests, or from the search language used on a customer's site. For purposes of the present disclosure, any training data 109 that are grouped and tagged can be used for training the system 100A and system 1006.

The question/answer transformer component 112 receives the training data 109 and the extracted data 111. The question/answer transformer component 112 may be implemented as a type of neural network architecture that uses a pre-trained transformer language model, such as but not limited to, T5 (described above) and Generative Pre-trained Transformer 3 (GPT-3) to provide summarization and question/answering language generation. The question/answer transformer component 112 processing is applied to each trained and tagged input from the training data 109 and to each item of extracted knowledge base context in the extracted data 111. Either all or a subset of the training data 109 for an intent may be used by the question/answer transformer component 112.

Suggested responses are stored in the second application database 114 in response data 115. The response data 115 also includes an answer confidence score. Many models provide the answer confidence score automatically as a part of the algorithm implemented by the models. Other scoring mechanisms may be used and stored in the response data 115. For example, if a confidence score is not provided by the model algorithm, other methods, such as that described in Xu, Jinxi, et al. “Answer Selection and Confidence Estimation.” New Directions in Question Answering, 2003 may be used. The disclosure of Xu, Jinxi, et al. is expressly incorporated herein by reference in its entirety. Alternatively, a Jaccard similarity index may be used to provide the answer confidence score. As noted above, the processes performed by the summarization component 118 of FIG. 18 may improve the performance of the question/answer transformer component 112.

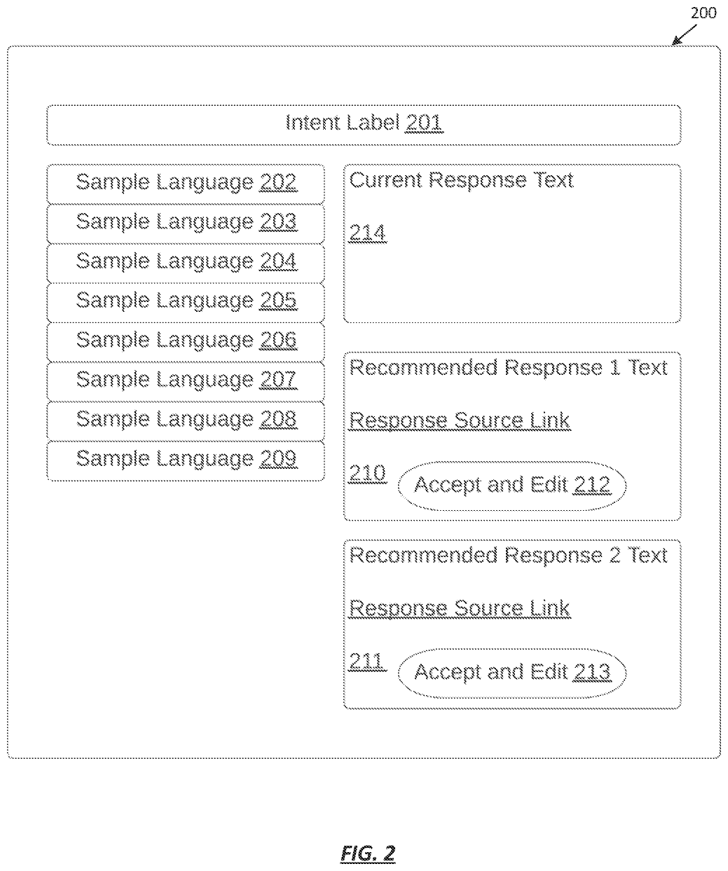

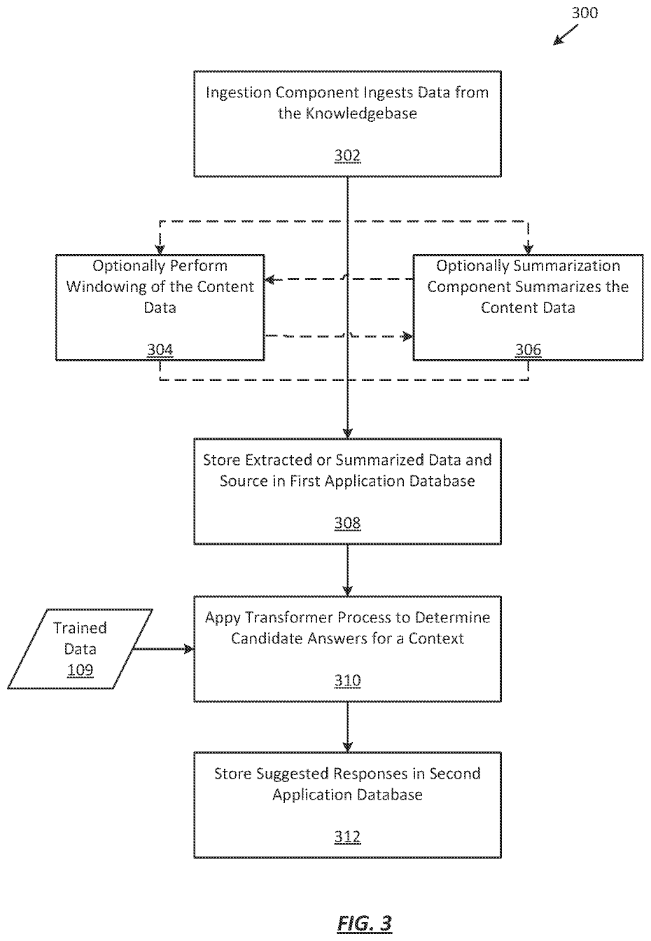

The selection component 116 receives the suggested response data 115 organized, for example, by the confidence score. As shown in FIG. 2, implementations of the present disclosure present a user interface 200 that includes an intent label 201, sample language (for example, a subset of the intent training language) 202-209, a current response 214, and suggested responses 210-211. The source of the suggested responses 210-211 may be made available to a user by clicking a link to a Uniform Resource Locator (URL) of the source. This enables the user to review the content that was extracted from knowledgebase 102. The user is also provided with the capability to accept and edit the suggested responses 210-211 by clicking on buttons 212-213, respectively. Accepting one of the suggested responses 210-211 will replace the current response 214. The newly accepted response will then be used.

In accordance with aspects of the present disclosure, the system may present a user with ranked suggested responses to questions for their respective intents, either by the confidence score, minimum similarity, or other methods, along with a link to or text from the original source for user to validate information presented in the response. The user may then accept the suggested response as a basis for a Conversational AI response as is or for editing.

FIG. 3 illustrates an example flow chart 300 of operations performed by the system 100A and/or 1008 to generate suggested responses. At block 302, the ingestion component 103 ingests content data from the knowledgebase 102 into the first application database 110. As noted above, the ingestion component 103 may ingest content data from the knowledgebase 102 using web scraping or other extraction techniques, such as a database dump using SQL.

Optionally and/or additionally, operations at blocks 304 and/or 306 may be performed to window the extracted data (block 304) and/or summarize the extracted data (block 306). Widowing at block 304 results in the same knowledgebase document (or other content data), producing multiple summarizations to use as contexts. Summarizing the extracted data 111 at block 306 removes superfluous subject matter in each document in the extracted data 111 such that the information may be more easily processed to provide answers to questions that are posed by customers interacting with the conversational AI.

At block 308, the extracted or summarized data from the knowledgebase 102 is stored in the first application database 110, together with information about the respective source of each item of the content data in extracted data 111.

At block 310, the question/answer transformer component 112 receives the training data 109 from the conversational AI database 108 and the extracted data 111 from the first application database 110 and applies a question/answer transformation process to determine suggested responses. The question/answer transformer component 112 applies the pre-trained transformer language model to each tagged, trained input in the training data 109 and for each item of extracted knowledge base context in the extracted data 111 to determine the suggested responses. The question/answer transformer component 112 also determines a confidence score based on intent.

At block 312, the suggested responses are stored in the second application database 114 as response data 115. The response data 115 also includes the knowledgebase score and the source from the extracted data 111.

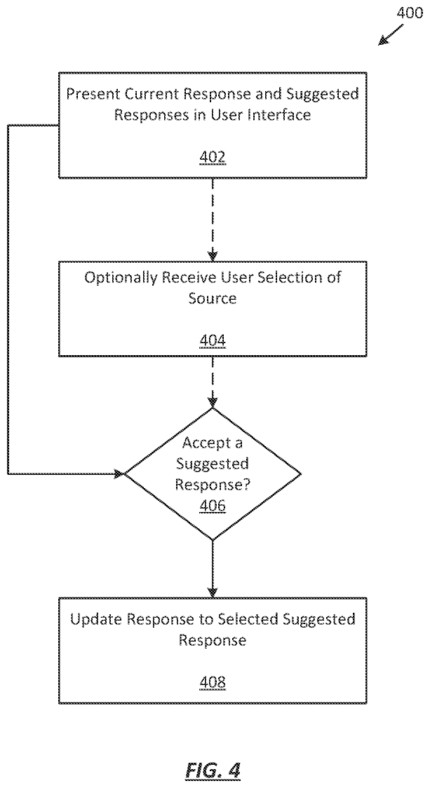

FIG. 4 illustrates an example flow chart 400 of operations by the system 100A and/or 1008 to present, edit, and/or accept suggested responses. The operations in the example flow chart 400 may be performed at any time after the operations at block 312 are completed. At block 402, the system presents a current response 214 and suggested responses 210-211 in a user interface 200. The system presents the top responses to questions for their respective intents, either by score, minimum similarity, or other methods, along with a link to or text from the original source for the user to validate the information presented in the response. Optionally or additionally, at block 404, a selection of a link to a source of the suggested responses 210-211 may be received from a user. This enables the user to review the content that was extracted from knowledgebase 102.

At block 406, it is determined if a user has indicated if a suggested response 210 or 211 is accepted and/or to be edited. The indication may be received as a selection of one of buttons 212-213, respectively. Accepting one of the suggested responses 210-211 will replace the current response 214.

At block 408, the newly selected suggested response replaces a current response. The newly selected recommended response will then be used by the conversation AI when responding to user inputs.

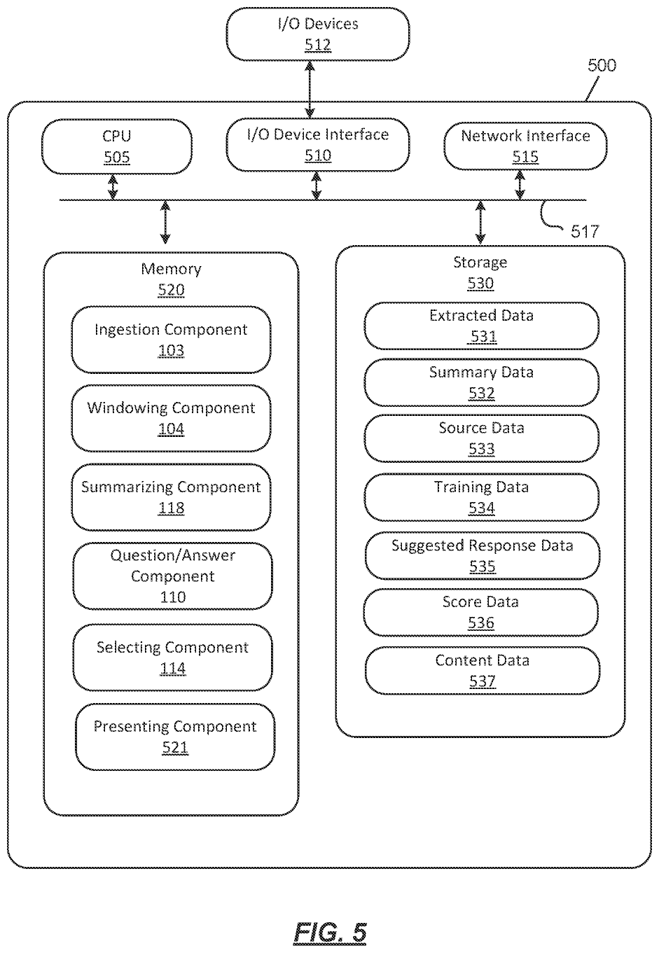

FIG. 5 illustrates an example of a computer system 500 that may include the kinds of software programs, data stores, and hardware according to certain embodiments. As shown, the computing system 500 includes, without limitation, a central processing unit (CPU) 305, a network interface 515, a memory 520, and storage 530, each connected to a bus 517. The computing system 500 may also include an I/O device interface 510 connecting I/O devices 512 (e.g., keyboard, display, and mouse devices) to the computing system 500. Further, the computing elements shown in computing system 500 may correspond to a physical computing system (e.g., a system in a data center) or may be a virtual computing instance executing within a computing cloud.

The CPU 505 retrieves and executes programming instructions stored in memory 520 as well as stored in the storage 530. The bus 517 is used to transmit programming instructions and application data between the CPU 505, I/O device interface 510, storage 530, network interface 515, and memory 520. Note, CPU 505 is included to be representative of a single CPU, multiple CPUs, a single CPU having multiple processing cores, and the like, and the memory 520 is generally included to be representative of random-access memory. The storage 530 may be a disk drive or flash storage device. Although shown as a single unit, the storage 530 may be a combination of fixed and/or removable storage devices, such as fixed disc drives, removable memory cards, optical storage, network-attached storage (NAS), or a storage area network (SAN).

Illustratively, the memory 520 includes the ingestion component 103, the widowing component 104, the summarization component 118, the question/answer transformer component 110, the selecting component 116 and a presenting component 521, all of which are also discussed in greater detail above with regard to FIGS. 1A, 1B, 2, 3 and 4.

Further, the storage 530 includes extracted data 531, summary data 532, source data 533, training data 534, suggested response data 535, score data 536 and content data 537, all of which are also discussed in greater detail above with regard to FIGS. 1A, 1B, 2, 3 and 4.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment. For example, the components described herein can be hardware and/or software components in a single or distributed system or in a virtual equivalent, such as a cloud computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Thus, the systems 100A and 100B and implementations therein described in the present disclosure provide an improved method(s) for presenting, editing, and accepting suggested responses for use by a conversational AI.

What is claimed:

1. A method of generating suggested responses, comprising:
ingesting, by an ingestion component, content data from a knowledgebase;
storing the content data in a first application database as extracted data;
applying, using a question/answer transformation component, a question and answer process to the extracted data using training data that is tagged by intent to determine suggested response data and a confidence score;
storing the suggested response data in a second application database;
selecting suggested response data in accordance with the confidence score; and
presenting selected suggested response data in a user interface.

2. The method of claim 1, further comprising windowing the content data to ingest a predetermined number of characters beginning from a starting point of the content data, wherein each item of content data produces multiple summarizations that are used as contexts for the question/answer transformer component.

3. The method of claim 1, further comprising summarizing the extracted data to remove superfluous subject matter in the extracted data that is unrelated to a predetermined intent.

4. The method of claim 1, further comprising:
storing the suggested response data in the second application database together with information regarding a respective source of each item of the content data in the extracted data; and
presenting the information regarding the respective source together with the suggested response data.

5. The method of claim 1, the question and answer process comprising determining the suggested response using a data neural network architecture to provide summarization and question/answering language generation.

6. The method of claim 5, wherein the question/answer transformer component determines the confidence score based on an intent.

7. The method of claim 1, further comprising:
presenting a current response and the suggested response data in a user interface, wherein the suggested response data is ranked the confidence score;
receiving a selection of at least one item of the suggested response data; and
replacing the current response with the selection of the at least one item of the suggested response data.

8. A computer system, comprising:
a memory comprising computer-executable instructions; and
a processor configured to execute the computer-executable instructions and cause the computer system to perform a method of generating suggested responses that causes the computer system to:
ingest, by an ingestion component, content data from a knowledgebase;
store the content data in a first application database as extracted data;
apply, using a question/answer transformation component, a question and answer process to the extracted data using training data that is tagged by intent to determine suggested response data and a confidence score;
store the suggested response data in a second application database;
select suggested response data in accordance with the confidence score; and
present selected suggested response data in a user interface.

9. The computer system of claim 8, further comprising instructions to window the content data to ingest a predetermined number of characters beginning from a starting point of the content data, wherein each item of content data produces multiple summarizations that are used as contexts for the question/answer transformer component.

10. The computer system of claim 8, further comprising instructions to summarize the extracted data to remove superfluous subject matter in the extracted data that is unrelated to a predetermined intent.

11. The computer system of claim 8, further comprising instructions to:
store the suggested response data in the second application database together with information regarding a respective source of each item of the content data in the extracted data; and
present the information regarding the respective source together with the suggested response data.

12. The computer system of claim 8, the question and answer process further comprising instructions to determine the suggested response using a data neural network architecture to provide summarization and question/answering language generation.

13. The computer system of claim 12, wherein the question/answer transformer component determines the confidence score based on an intent.

14. The computer system of claim 8, further comprising instructions to:
present a current response and the suggested response data in a user interface, wherein the suggested response data is ranked the confidence score;
receive a selection of at least one item of the suggested response data; and
replace the current response with the selection of the at least one item of the suggested response data.

15. A non-transitory computer readable medium comprising instructions that, when executed by a processor of a processing system, cause the processing system to perform a method of generating suggested responses, comprising instructions to:
ingest, by an ingestion component, content data from a knowledgebase;
store the content data in a first application database as extracted data;
apply, using a question/answer transformation component, a question and answer process to the extracted data using training data that is tagged by intent to determine suggested response data and a confidence score;
store the suggested response data in a second application database;
select suggested response data in accordance with the confidence score; and
present selected suggested response data in a user interface.

16. The non-transitory computer readable medium of claim 15, further comprising instructions to window the content data to ingest a predetermined number of characters beginning from a starting point of the content data, wherein each item of content data produces multiple summarizations that are used as contexts for the question/answer transformer component.

17. The non-transitory computer readable medium of claim 15, further comprising instructions to summarize the extracted data to remove superfluous subject matter in the extracted data that is unrelated to a predetermined intent.

18. The non-transitory computer readable medium of claim 15, further comprising instructions to:
store the suggested response data in the second application database together with information regarding a respective source of each item of the content data in the extracted data; and
present the information regarding the respective source together with the suggested response data.

19. The non-transitory computer readable medium of claim 15, the question and answer process further comprising instructions to determine the suggested response using a data neural network architecture to provide summarization and question/answering language generation.

20. The non-transitory computer readable medium of claim 15, further comprising instructions to:
present a current response and the suggested response data in a user interface, wherein the suggested response data is ranked the confidence score;
receive a selection of at least one item of the suggested response data; and
replace the current response with the selection of the at least one item of the suggested response data.
